(19) United States
(12) Patent Application Publication
(10) Pub. No.: US 2008/0202569 A1
(43) Pub. Date: Aug. 28, 2008

(54) Cleaning Device

(76) Inventors: Franklin David Chandra, Bangalore (IN); Suresh Sambamurthy Jayaraman, Bangalore (IN); Kartik Kumar, Vlaardingen (NL); Vijay Mukund Naik, Bangalore (IN); Venkatraghavan Rajanarayana, Bangalore (IN); Janhavi Sanjay Raut, Bangalore (IN); Amit Kumar Singh, Gainesville, FL (US); Sumit Taraphdar, Stony Brook, NY (US)

Correspondence Address: UNILEVER PATENT GROUP, 800 SYLVAN AVENUE, AG West S. Wing, ENGLEWOOD CLIFFS, NJ, 07632-3100, US

(21) Appl. No.: 11/791,260

(22) PCT Filed: Nov. 16, 2005
(86) PCT No.: PCT/EP05/12366

§ 371 Date: Dec. 19, 2007

(30) Foreign Application Priority Data
Nov. 25, 2004 (IN) 1266/MUM/2004

(51) Int. Cl. B08B 3/10

(52) U.S. Cl. 134/58 R; 134/94.1

(57) ABSTRACT

A device is provided to clean an object by positioning the surface of the object to be cleaned in contact with a cleaning medium comprising one or more liquids having a dielectric constant of from 1 to 200 and placed in an electric field in the range of from 103 V/m to 107 V/m wherein said device is capable of generating said electric field using an alternating voltage/current source, said device comprising at least two electrodes where one of the electrodes is at a higher potential than the other and said electrodes are spatially separated by a distance of 1 micron to 2 cm by an insulating material having a dielectric breakdown strength greater than the applied electric field.

### TECHNICAL FIELD

The invention relates to a device for cleaning of articles or objects, when they are in contact with a liquid, under the application of an electric field, with or without scrubbing, agitation, fluid flow, etc., caused by mechanical or other means.

### BACKGROUND AND PRIOR ART

There is a large volume of information on the methods available for cleaning articles and objects. The method adopted to clean such articles and objects often depends on the nature of soil, the nature of article or object, degree of cleanliness required and the cleaning agents/methods available. The articles and objects most often encountered in every day life are made from materials like wood, ceramic, stone, china clay, glass, natural and synthetic fibers, metals, alloys, modern synthetic polymers and composites thereof, among a host of others. There are also several articles and objects made of similar materials, which are encountered in various industries, which need to be cleaned before they are reused or further processed, or are produced as finished products.

There are several known methods of cleaning articles and objects and these can be broadly classified as:
(i) Mechanical/physical methods like scrubbing, buffing, abrasion, ultrasonication;
(ii) Physico-chemical/Chemical methods, such as those involving the use of surfactants, solvents, acids, alkalis, bleaches and enzymes;
(iii) Or a combination of two or more of the above methods.

Every method has its inherent advantages and disadvantages. Mechanical/physical means/methods may give a good surface cleaning but this may not be applicable to systems with inaccessible parts. These methods may also damage or erode the surface. Physicochemical/chemical methods, apart from being expensive, may also damage or corrode the surface of the article or object, and additionally may have an adverse environmental impact after use.

In spite of the large number of methods available for cleaning, there is a constant need to develop better methods to clean, which work faster, are more economical, and have minimal adverse effect on the article or object and the environment.

In our co-pending Indian patent application no. 549/Mum/2003 it has been disclosed that it is possible to clean articles or objects by placing them in an electric field, in contact with a liquid preferably water which may additionally comprise small amount of surfactant and/or a thickening agent.

There are various types of devices known in the art to improve cleaning. The use of a scrubber is advantageous in cleaning as it helps to remove tough dirt like that found on the collar and cuffs as well as stains. US20040084063 discloses electrically powered stain-removal brushes for fabrics or inanimate hard surfaces. These stainbrushes and electric stainbrush heads include shafts that rotate, oscillate, or reciprocate (as well as combinations thereof) to impart motion to the bristle holders.

Ultrasonic cleaning devices for domestic use in removing stains and soils from domestic surfaces, including hard surfaces and fibrous surfaces are known.

WO2003033179 discloses ultrasonic cleaning device for improved cleaning of various surfaces such as fabric.

EP1004264 discloses a process of cleaning carpets and other large fabric coverings with a product dispensed from a device, said device comprising a reservoir for the product, means for dispensing the product, a spray arm and at least one dispensing opening, the process being characterized in that the reservoir is a removable cartridge. The packaged product is used for spraying household cleaning or laundry products, or perfumes and is used for the cleaning of surfaces such as fabrics, carpets, floors, and ceilings. The packaged product is delivered by a manually or electrically driven pump. In this way, the product delivering means connected to a reservoir constitutes an electrical spraying device. The process of cleaning essentially comprises applying 1 ml to 120 ml per square meter the composition onto the carpet in the form of a spray of droplets and leaving said composition to dry onto the carpet, and optionally removing it by vacuum cleaning said carpet.

However, there are no devices that generate electric field which is used for cleaning articles or objects by placing them in such an electric field, in contact with a liquid preferably water which may additionally comprise small amount of surfactant and/or a thickening agent.

### OBJECTS OF THE INVENTION

It is thus an object of the present invention to provide a device to remove soils and deposits from a large number of common articles or objects made of metals, polymers/plastics, natural as well as synthetic fibers, glass, ceramics, wood, stone and the like; and the alloys/composites/wovens/non-wovens/layers and combinations there of.

It is another object of the present invention to provide a device that is capable 25 of generating an electric field in the range of 10³ V/m to 10⁷ V/m in order to remove soils and deposits from articles or objects.

It is another object of the present invention to provide a device that is capable of generating an electric field in the range of 10³ V/m to 10⁷ V/m in order to remove soils and deposits from articles or objects without or with the use of a minimal amount of a chemical cleaning agent e.g. surfactant, being used.

It is another object of the present invention to provide a device that is capable of generating an electric field in the range of 10³ V/m to 10⁷ V/m in order to remove soils and deposits from articles or objects without or with the use of a minimal amount of a chemical cleaning agent, in an economical and efficient manner.

Another object of the present invention to provide a device that is capable of generating an electric field in the range of 10³ V/m to 10⁷ V/m in order to remove soils and deposits from articles or objects without or with the use of a minimal amount of a chemical cleaning agent in an inexpensive and safe manner in a short time without causing any substantial change to the characteristics of the article or object and thereby minimizing the generation of environmentally unsafe effluents during the cleaning process.

### SUMMARY OF THE INVENTION

According to the present invention there is provided a device to clean an object by positioning the surface of the object to be cleaned in contact with a cleaning medium comprising one or more liquids having a dielectric constant of from 1 to 200 and placed in an electric field in the range of 10³ V/m to 10⁷ V/m wherein said device is capable of generating said electric field using an alternating voltage/current source, said device comprising at least two electrodes where one of the electrodes is at a higher potential than the other and said electrodes are spatially separated by a distance of 1 micron to 2 cm by an insulating material having a dielectric breakdown strength greater than the applied electric field.

It is particularly preferred that the surface of the article or object to be cleaned is in contact with water and the required electric field is generated in that.

### DETAILED DESCRIPTION OF THE INVENTION

The essential features of the invention relates to a device that is capable of generating an electric field in the range of 10³ V/m to 10⁷ V/m in order to remove soils and deposits from articles or objects by contacting the surface of the said article/object with one or more liquids having a dielectric constant of from 1 to 200. The device can be designed to be a hand held one or in the form of a washing machine.

### Electrode:

The device is provided with at least two electrodes which aids in generating the electric field. One of the electrodes is at a higher potential than the other and are spatially separated by a distance of 1 micron to 2 cm and preferably 10 microns to 1000 microns by using an insulating material having a dielectric breakdown strength greater than the applied electric field and is preferably greater than 10⁷ volts/m. The potential difference between the electrodes is in the range 10⁻³ to 2×10⁵ volts. It is possible to provide a plurality of electrodes in various configurations. The electrodes can be placed on the same side as the object to be cleaned or on the opposite sides of the object to be cleaned.

The electrodes are mounted on an electrode holder and the electrode holder is capable of synchronised reciprocating or rotary movement in association with said electrode.

The electrodes are made up of conducting/semi-conducting materials e.g. metals, conducting polymers, metalloids or combinations thereof. The electrodes can be made from materials, like stainless steel, copper, aluminum, conducting polymers, etc. The conducting electrodes may also be prepared by coating a conducting material on other semiconducting/dielectric/leaky dielectric materials. The conducting electrodes may also be coated, painted or inked with other conducting/semi-conducting/dielectric/leaky dielectric materials. The shape and size of the electrodes are designed based on the application. It is also possible that the article or object to be cleaned is used as one of the electrodes.

The electrodes can be placed in parallel or concentric or any other suitable configuration wherein the electrodes of one potential are connected together and separated from the other electrode with a higher or lower potential by an insulating material with a dielectric breakdown strength preferably greater than 10⁷ volts/m. The thickness of the exposed portion of the each electrode of the plurality of electrodes can vary from 100 microns to about 0.5 cm. The electrodes are preferably made flexible so as to enable the user to freely move it on the surface of the object to be cleaned.

The insulating material that separates the electrodes can be organic or inorganic and is selected from polymers, ceramics, mica, glass, bakelite, teflon, polyethylene, polypropylene, plastic, paper, cotton, polyester, epoxy, resins, binders, adhesives, and the like.

Each electrode at one potential is separated from the other with a higher or lower potential by individually coating the contact surface with one or more of the materials mentioned herein and then assembling them suitably or the electrodes are assembled suitably and the insulating material is allowed flow in between to maintain the distance.

### Cleaning Medium:

The cleaning medium in which the object to be cleaned is placed where the electric field is generated comprises one or more liquids with a dielectric constant in the range 1 to 200.

For the purposes of this invention, the word “liquid” refers to all media in the liquid state including liquids whose consistency has been modified by the use of thickening agent and includes media in the solution, emulsion, suspension and gel states. The liquids may be in a single phase or multiple phases.

Any liquid having a dielectric constant in the range of 1 to 200 can be used. Suitable solvents that can be used include water and organic solvents including compounds of the class of alkanes, aliphatic and aromatic alcohols, primary and secondary amides and mixtures thereof. Liquids having a dielectric constant in the range of 1 to 100 are particularly preferred.

It is particularly preferred that the liquid used is water. It is also preferred that any other liquids may be used mixed with water so long as the dielectric constant of the resultant composition is in the range of 1 to 200.

Although, it is not essential as per the method of the present invention that the liquid used is in motion, it is possible that the liquid could be flowing at a suitable flow rate, and could be replenished or recirculated.

The device comprises a means to generate positive and/or negative pressure between the electrode and the object to be cleaned. This will ensure removal of the dislodged soil and in keeping the cleaning medium replenished or recirculated. The means to generate positive and/or negative pressure is a suction means and/or a pump.

The method as per the invention can also be carried out in combination with any other known method of cleaning e.g. mechanical methods like agitation, scrubbing, ultrasonication, etc, although this is not an essential feature of the invention. The device advantageously can be provided with a scrubbing means that is capable of synchronised reciprocating or rotary movement in association with said electrode and the scrubbing means is provided with at least one bristle head.

Additional cleaning aids if required are dispensed from a reservoir and a pump is positioned between said reservoir and said electrode for dispensing the cleaning aid. The device is provided with one or more motors for enabling the movement of the electrode holder, scrubbing means and activation of the pump and the motor is connected to a source of power.

### Articles or Objects to be Cleaned:

The article or object to be cleaned can be made of any solid material whose surface is hard or soft or porous, and can be a good or a poor conductor of electricity or a dielectric. Preferred articles or objects that can be cleaned by the device of the present invention include those made of metals, polymers/plastics, natural as well as synthetic fibers, glass, ceramics, wood, stone and the like; and the alloys/composites/wovens/non-wovens/layers and combinations there of. It is also possible that the article or object to be cleaned is used as one of the electrodes.

### Concentration and Type of Surfactants

It is preferred that the article or object to be cleaned is in contact with additional cleaning aids such as a dilute aqueous solution of surfactants or thickening agents or gels, and the said article or object is placed in an electric field in the range of 10³ V/m to 10⁷ V/m, generated using an alternating voltage/current source. It is preferred that the concentration of the surfactant in water is such that the surface tension of the surfactant solution is in the range of 15-50 mN/m. The invention can also be worked at higher surfactant concentrations.

Examples of zwitterionic or amphoteric or nonionic or anionic or cationic surfactant species that fall within the scope of the present invention are given in the following well-known textbooks: (i) “Surface Active Agents”, Volume I by A. M. Schwartz and J. W. Perry, (ii) “Surface Active Agents and Detergents”, Volume II by A. M. Schwartz, J. W. Perry and J. Berch, (iii) “Handbook of Surfactants” by M. R. Porter, (iv) “Amphoteric Surfactants” by E. G. Lomax.

Although any surfactant may be used, it is preferred that the surfactant used is of the non-ionic, amphoteric or zwitterionic type.

The word “amphoteric surfactant” is used to describe surface active molecules for which the ionic character of the polar group depends on the solution pH. The word “zwitterionic surfactants” is used to describe surface active molecules that contain both positively and negatively charged groups.

Suitable amphoteric and zwitterionic surfactant compounds that can be employed are those containing quaternary ammonium, sulfonium, oxonium or phosphonium ions as cations, and carboxylate, sulfonate, sulfate, sulfite, phosphinate, phosphonite, phosphito or phosphato groups as anions.

Particular non-limiting examples of zwitterionic or amphoteric surfactants include alkyl amino acids, alkyl betaines, alkyl iminiodiacids, alkyl imidazoline derived amphoterics, alkyl poly amino carboxylates, alkyl ammonio dimethyl propyl sufonates, phosphatidylcholines, sulfonium betaines, phosphonium betaines, sulfobetaines, sufitobetaines, sulfatobetaines, phophinate betaines, phosphonate betaines, phosphitobetaines, phosphatobetaines and alkyl ammonio sulfonates.

The invention provides for a device to clean surface of articles or objects when they are in contact with a liquid with specific properties and is placed in an electric field. It is also possible that the liquid is formulated as a solution, an emulsion, or a gel or any other physical form. When the liquid is formulated, it is particularly preferred that the liquid is present as a gel. This may be achieved by adding suitable thickening agents to the liquids. Suitable thickening agents include natural polysaccharides like starch, modified starch, modified celluloses and natural gums and synthetic polymers including polyvinyl alcohol, polyacrylates and poyacrylamides.

### Alternating Electric Field:

The article/object to be cleaned is placed in an electric field generated using an alternating voltage/current source. The article is preferably placed between two electrodes, and is subject to an alternating field by connecting a source of alternating voltage/current across the electrodes.

The electric field between the electrodes is determined by dividing the measured voltage drop across the electrodes by the distance between the electrodes, and is suitably represented as V/m. Thus, the electric field strength depends both on the voltage applied as well as the distance between the electrodes. The suitable range of electric field for the purpose of the present invention is 10³ V/m to 10⁷ V/m.

The term alternating means periodic or non-periodic time variance and time reversal of the corresponding parameter. If the alternating voltage/current source gives periodic variation, the resultant voltage/current wave-form could be of any shape, such as sinusoidal, triangular, square or pulsed, or combinations thereof.

The accompanying drawings, which are incorporated in and form a part of the specification, illustrate the preferred embodiments of the present invention, and together with the description serve to explain the principles of the invention and do not limit the invention in any way.

### BRIEF DESCRIPTION OF THE DRAWINGS

FIG. 1. Is a side view of a hand held device capable of generating the required electric field in which the electrodes are positioned on the same side of the object to be cleaned with a reciprocating brush.

FIG. 2. Is a side view of a hand held device capable of generating the required electric field in which the electrodes are positioned on opposite sides of the object to be cleaned, with a reciprocating brush.

FIG. 3. Is a side view of a hand held device capable of generating the required electric field in which the electrodes are positioned on the same side of the object to be cleaned without the brush, and the electrodes are capable of reciprocation.

FIG. 4. Is a side view of a hand held device capable of generating the required electric field with a rotary brush.

FIG. 5. Is another embodiment of the invention in the form of a bulk washing machine.

FIG. 6. A front view of the electrodes in a square, parallel interdigitated configuration.

FIG. 7. A front view of the electrodes in circular concentric configuration.

FIG. 8. A front view of the electrodes in circular interdigitated configuration useful for rotating electrodes.

### DETAILED DESCRIPTION OF THE DRAWINGS

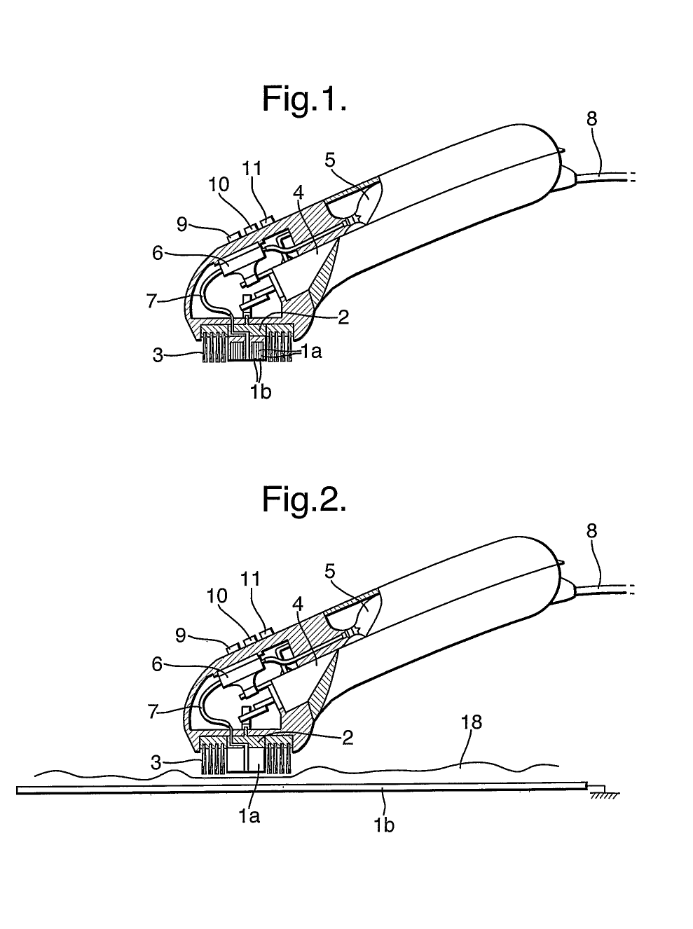

FIG. 1, shows a hand held device capable of generating the required electric field in which the electrodes are positioned on the same side of the object to be cleaned. In FIG. 1, plurality of electrodes (1a and 1b) are spatially separated from each other. One set of electrodes has a higher potential than the other and these electrodes are mounted on an electrode holder (2) and are surrounded by the bristles of the brush (3). On pressing the switch (9) the gel pump (6) is activated which pumps the gel from the gel chamber (5). The gel flows through the tubing (7) which is meant for dispensing the gel on to the object to be cleaned for e.g. the fabric. It is also possible to have a mechanism by which the gel can be filtered and recirculated. On activation of switch (10) the brush (3) is moved in a reciprocating movement by the motor (4). This movement helps in spreading the gel on the object. On activation of switch (11) the electric field generated dislodges the soil from the object and the brush helps in dispersing the loosened soil. The hand held device is connected to the main power supply by the bundle of cords (8). This supplies the power for the gel pump (6), motor (4) and the electrodes (1a and 1b).

In use the device is connected to the main power supply and that enables the action of the gel pump, motor and the electrodes. The device is kept in contact with the object to be cleaned such as a fabric by bringing the electrodes in contact with the fabric and is moved along the fabric to cover the different parts to be cleaned. The dispensed gel, the scrubbing effect provided by the brush and electric field generated by the electrodes provides superior cleaning.

FIG. 2, discloses a hand held device capable of generating the required electric field in which the electrodes are positioned on opposite sides of the object to be cleaned. In FIG. 2, (1a) and (1b) are the two sets of electrodes and are positioned on either side of the object for e.g a fabric (18) and electrode (1a) is maintained at a higher potential than the electrode (1b). The rest of the functioning of the device is similar to FIG. 1.

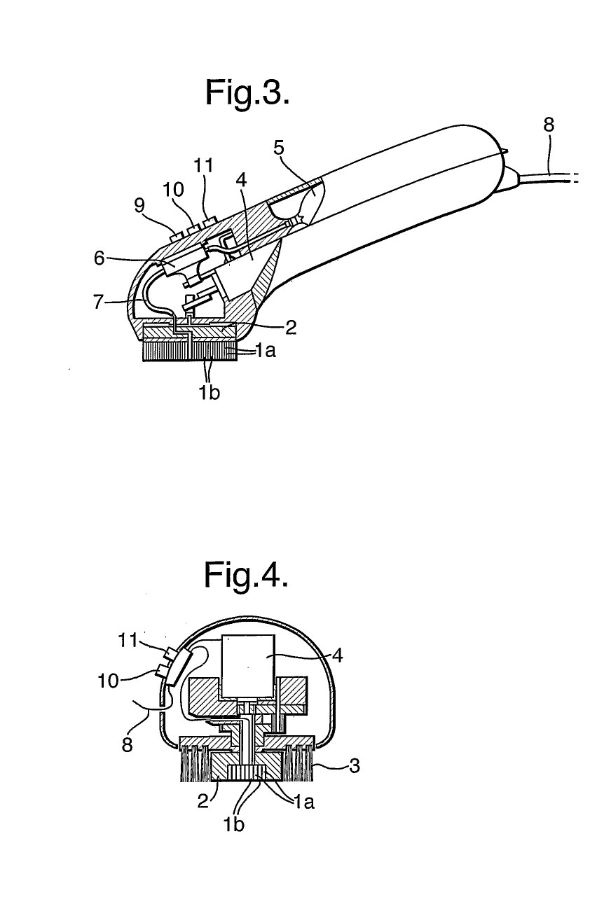

FIG. 3, discloses a hand held device capable of generating the required electric field in which the electrodes with reciprocating movement are positioned on the same side of the object to be cleaned. The device is not provided with additional scrubbing means.

FIG. 4, discloses a hand held device capable of generating the required electric field with a rotary brush. The gel chamber and the dispensing mechanism are external to the device.

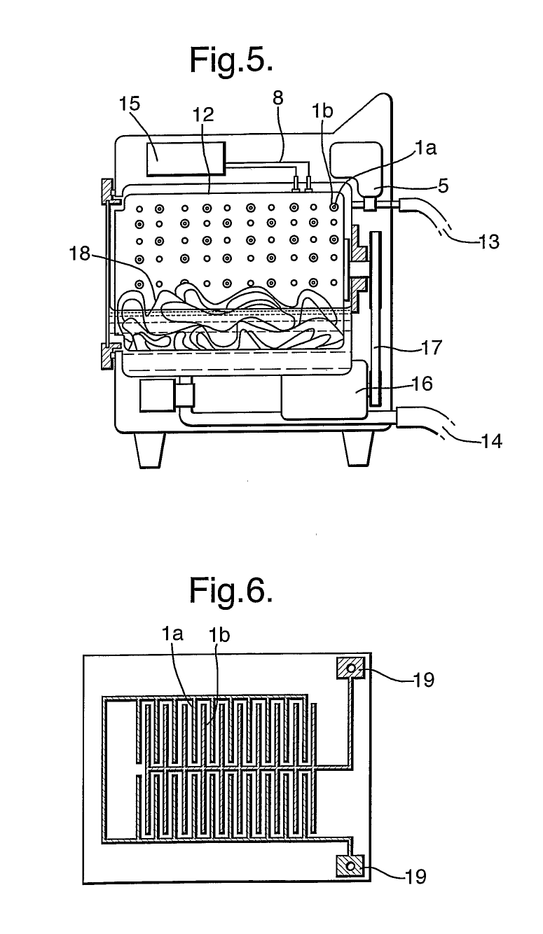

FIG. 5, is a device where the washing mechanism is in the form of a washing machine so as to enable washing of more than one object simultaneously and in an automated fashion.

The object (18) in this example it is fabric, to be cleaned are taken in a rotating drum (12). Water can be introduced into the drum through the inlet (13) that can also carry the gel from the gel chamber (5). The body of the drum is provided with electrode (1a) and (1b) where one set of electrodes is at a higher potential as compared to the other. The power supply (15) supplies power to the motor (16) to can get the rotating drum into motion with the help of the belt drive (17). The power supply (15) also supplies power to the electrodes for generating electric field in the water containing the cleaning aids inside the drum. This provides the agitation as well as the electric field for the cleaning. It is possible to drain the water and other cleaning aids through the outlet 14 and if required the excess water from objects such as fabric can be removed.

FIG. 6, shows the electrodes in a square parallel interdigitated configuration. Electrode (1a) and (1b) are maintained at different potentials such that one electrode is at a higher potential than the other electrode. The plurality of plates forming electrode (1a) and (1b) are respectively connected to a connector (19).

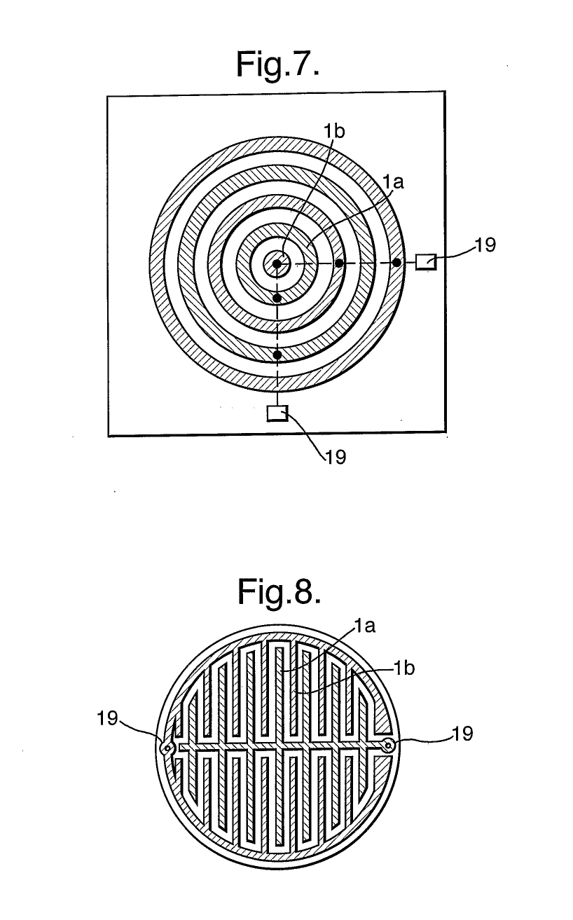

FIG. 7 is same as FIG. 5 but the electrodes are in a circular concentric configuration.

In FIG. 8 the electrodes are in a circular interdigitated configuration useful for rotating electrodes.

### EXAMPLE

### Determination of the Efficacy of the Device:

A pre-soiled fabric swatch, procured from the wfk-Cleaning Technology Research Institute, Campus Fichtenhain 11-D-47807 Krefeld, Germany, was taken. The fabric, referred to as WFK20D by the supplier, is a blend of polyester (synthetic) and cotton (natural) fibers, and contains composite soil. The reflectance of the fabric was measured at 460 nm wavelength. The fabric swatch was then placed in a bath under various conditions as mentioned below. A hand held device as shown in figure was then used to clean the swatch. The device attached to a reciprocator operating at ˜24 strokes/minute with a stroke length of 10 cm was used to provide the agitation.

### EXAMPLE 1

Water containing a Zwitterionic surfactant, 3-(N,N-Dimethylpalmitylammonio)-propansulphonate (C₂₁H₄₅NO₃S), at 6000 ppm.

### EXAMPLE 2

Water containing a Zwitterionic surfactant, 3-(N,N-Dimethylpalmitylammonio)-propansulphonate (C₂₁H₄₅NO₃S), at 6000 ppm with electric field generated using the hand held device was then used to clean the swatch. An electric filed of 2×10⁵ V/m was applied at 50 volts across 250 micron gap at 50 Hz AC.

### EXAMPLE 3

Water containing a Zwitterionic surfactant, 3-(N,N-Dimethylpalmitylammonio)-propansulphonate (C₂₁H₄₅NO₃S), at 6000 ppm and 0.5% by wt. thickener Gelrite Gellan Gum (Sigma-Aldrich, USA) in aqueous solution.

### EXAMPLE 4

Water containing a Zwitterionic surfactant, 3-(N,N-Dimethylpalmitylammonio)-propansulphonate (C₂₁H₄₅NO₃S), at 6000 ppm and 0.5% by wt. thickener Gelrite Gellan Gum (Sigma-Aldrich, USA) with electric field generated using the hand held device was then used to clean the swatch. An electric filed of 2×10⁵ V/m was applied at 50 volts across 250 micron gap at 50 Hz AC.

The fabric was subsequently rinsed and the reflectance of the fabric after drying was measured at 460-nm wavelength. The increase in the reflectance (ΔR*) of the fabric over that measured before the cleaning process, determines the cleanliness of the fabric. The data is presented in Table 1.

TABLE 1

| Examples | Detergency (ΔR*) |
|---|---|
| Example 1 | 18 |
| Example 2 | 21 |
| Example 3 | 16 |
| Example 4 | 23 |

The data presented in Table 1 show that use of electric field improves the detergency significantly and addition of the gel further improves the cleaning performance only in presence of the electric field.

Thus it has been possible by way of the present invention to provide a device that is capable of generating the required electric filed to enhance cleaning of objects.

1. A device to clean an object by positioning the surface of the object to be cleaned in contact with a cleaning medium comprising one or more liquids having a dielectric constant of from 1 to 200 and placed in an electric field in the range of from 10³ V/M to 10⁷ V/m wherein said device is capable of generating said electric field using an alternating voltage/current source, said device comprising at least two electrodes where one of the electrodes is at a higher potential than the other and said electrodes are spatially separated by a distance of 1 micron to 2 cm by an insulating material having a dielectric breakdown strength greater than the applied electric field.

2. A device as claimed in claim 1 wherein said electrodes are spatially separated by a distance of 10 microns to 1000 microns.

3. A device as claimed in claim 1 wherein said electrodes are spatially separated by an insulating material having a dielectric breakdown strength greater than 10⁷ volts/m.

4. A device as claimed in claim 1 wherein said insulating material is an organic or inorganic material.

5. A device as claimed in claim 1 wherein said insulating material is selected from polymers, ceramics, mica, glass, Bakelite, Teflon, polyethylene, polypropylene, plastic, paper, cotton, polyester, epoxy, resins, bonders and adhesives.

6. A device as claimed in claim 1 wherein there is a plurality of electrodes and configurations.

7. A device as claimed in claim 1 wherein said electrodes are on the same side of the object to be cleaned.

8. A device as claimed in claim 1 wherein said electrodes are on the opposite sides of the object to be cleaned.

9. A device as claimed in claim 1 wherein the electrodes are mounted on an electrode holder.

10. A device as claimed in claim 9 wherein said electrode holder is capable of synchronized reciprocating or rotary movement in association with said electrode.

11. A device as claimed in claim 1 wherein said electrode is made of any conducting/semi-conducting materials selected from metals, conducting polymers, metalloids or combinations thereof.

12. A device as claimed in claim 1 comprising a scrubbing means that is capable of synchronized reciprocating or rotary movement in association with said electrode.

13. A device as claimed in claim 12 wherein said scrubbing means is provided with at least one bristle head.

14. A device as claimed in claim 1 wherein said device comprises a means to generate positive and/or negative pressure between said electrode and the object to be cleaned.

15. A device as claimed in claim 14 wherein said means to generate positive and/or negative pressure is a suction means and/or a pump.

16. A device as claimed in claim 1 wherein said device comprises a reservoir for dispensing a cleaning aid.

17. A device as claimed in claim 1 wherein said cleaning aid is surfactant and/or a thickening agent.

18. A device as claimed in claim 1 wherein said device comprises a pump positioned between said reservoir and said electrode for dispensing said cleaning aid.

19. A device as claimed in claim 1 that comprises one or more motors for enabling the movement of the electrode holder, scrubbing means and activation of said pump.

20. A device as claimed in claim 17 wherein said motor is connected to a source of power.

21. A device as claimed in claim 1 wherein said device is used to clean substrates chosen from metals, polymers, plastics, natural or synthetic fibers, glass, ceramics, wood, stone and combinations thereof including alloys, composites, wovens, non-wovens and layers.
